(19) United States
(12) Patent Application Publication
(10) Pub. No.: US 2009/0134636 A1
(43) Pub. Date: May 28, 2009

(54) LATCH MECHANISM

(75) Inventor: MING-CHANG LEE, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/965,748

(22) Filed: Dec. 28, 2007

(30) Foreign Application Priority Data
Nov. 26, 2007 (CN) 200710202658.0

(51) Int. Cl. E05C 1/12

(52) U.S. Cl. 292/174

(57) ABSTRACT

A latch mechanism for locking a cover unit to a base unit which comprises a bottom panel and a cover panel fixed to the bottom panel and defining a through hole, includes a latch member configured for being slidably installed to the bottom panel and between the bottom panel and the cover panel, a hook protruding from the cover unit, a button movably fixed to the bottom panel, and a resilient member connected to the button configured for restoring the button. The latch member includes a latch portion and a sliding slot. The hook extends through the through hole of the cover panel to engage with the latch portion of the latch member. The button includes a driving portion sliding in the sliding slot of the latch member for driving the latch member to slide toward the button to disengage from the hook.

### BACKGROUND

1. Field of the Invention

The present invention relates to latch mechanisms, and more particularly to a latch mechanism for a portable computer.

2. Description of Related Art

Typically, an electronic device, such as a portable computer, includes a cover unit and a base unit pivotably connected to the cover unit, and a latch mechanism is provided to lock the cover unit to the base unit.

As disclosed in U.S. Pat. No. 6,115,239, a latch mechanism for locking a cover unit to a base unit, includes a latch frame movably installed inside the cover unit, a plurality of latches are formed on the latch frame at predetermined intervals and one end portion of each latch protrudes from a front surface of the cover unit, and a slide knob is operatively connected to the latch frame for concurrently operating the latches. The latches are inserted into and locked by latch grooves formed at positions corresponding to the latches on an upper surface of the base unit. The latches are urged against the base unit by elastic forces applied by double springs mounted to two ends of the latch frame. However, to open the cover unit, the slide knob is slid to overcome the elastic forces of the springs to move the latch mechanism for disengaging from the base unit. The slide force depends on friction between the slide knob and fingers of an operator. It is laborious for an operator to provide enough force to move a slide knob.

What is needed, therefore, is a laborsaving latch mechanism.

### SUMMARY

In one embodiment, a latch mechanism for locking a cover unit to a base unit which comprises a bottom panel and a cover panel fixed to the bottom panel and defining a through hole therein, includes a latch member configured for being slidably installed to the bottom panel and between the bottom panel and the cover panel, a hook protruding from the cover unit, a button movably fixed to the bottom panel, and a resilient member connected to the button configured for restoring the button. The latch member includes a latch portion and a sliding slot. The hook extends through the through hole of the cover panel to engage with the latch portion of the latch member. The button includes a driving portion sliding in the sliding slot of the latch member for driving the latch member to slide toward the button to disengage from the hook.

Other advantages and novel features of the present invention will become more apparent from the following detailed description of an embodiment when taken in conjunction with the accompanying drawings, in which:

### BRIEF DESCRIPTION OF THE DRAWINGS

FIG. 1 is an exploded, isometric view of a latch mechanism with a cover unit and a base unit in accordance with an embodiment of the present invention, the base unit including a bottom panel and a cover panel;

FIG. 2 shows another aspect view of the cover unit of FIG. 1;

FIG. 3 is an enlarged view of the latch mechanism with the bottom panel of FIG. 1;

FIG. 4 is an assembled view of the latch mechanism together with the bottom panel of FIG. 1; and

FIGS. 5 and 6 are cross-sectional, partial views of the latch mechanism, showing two using states respectively.

### DETAILED DESCRIPTION

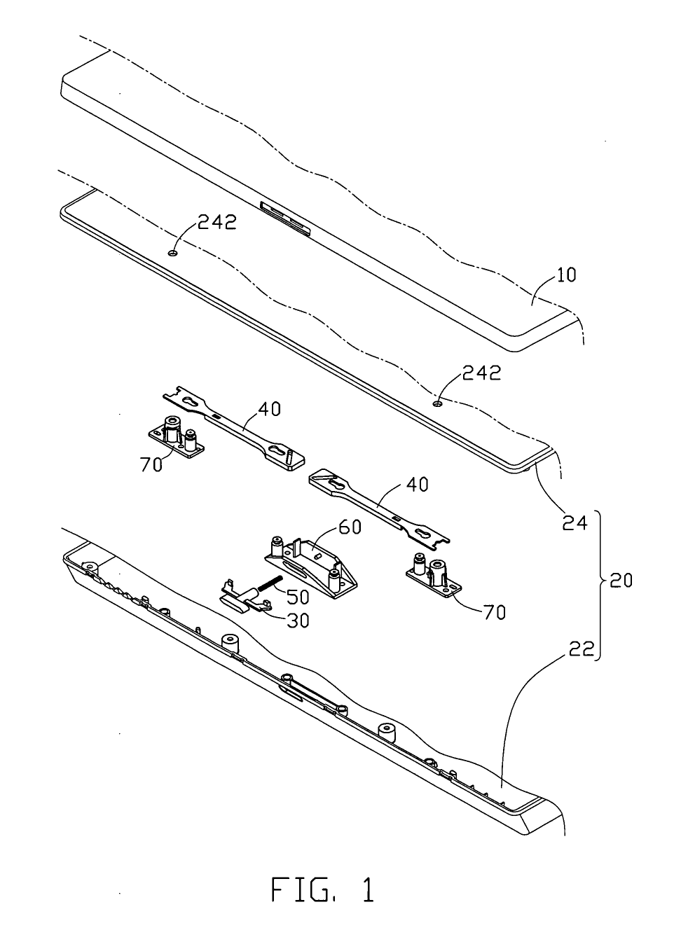

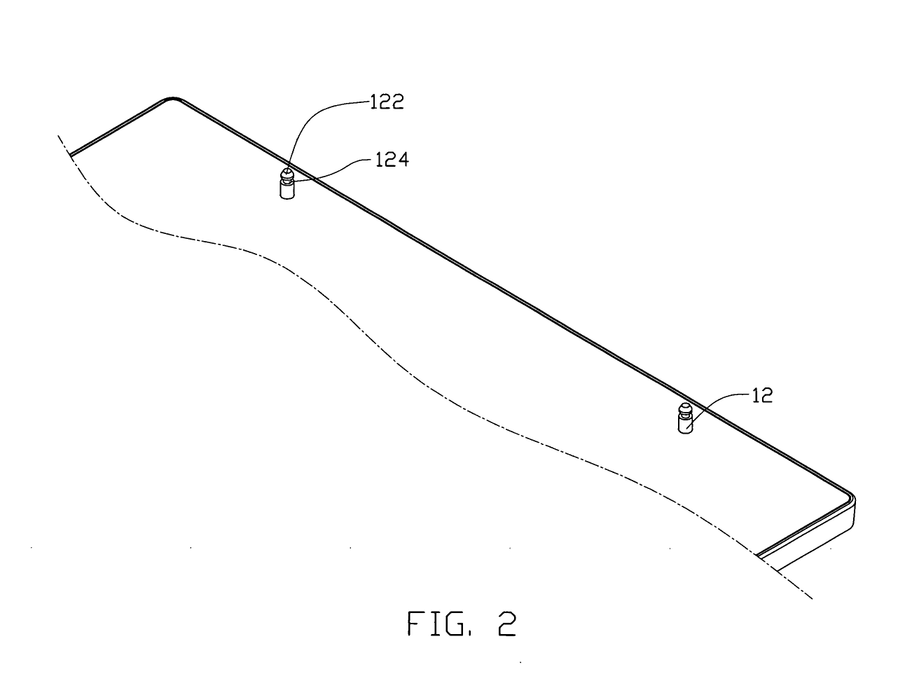

Referring to FIGS. 1 and 2, a latch mechanism in accordance with an embodiment of the present invention is provided, for locking a cover unit 10 to a base unit 20 of an electronic device, such as a portable computer. The latch mechanism includes a button 30, two latch members 40, a resilient member 50, a mounting member 60, and two supporting members 70. In this embodiment, the resilient member 50 is a coil spring.

The cover unit 10 includes two hooks 12 arranged thereon at one side surface thereof. Each hook 12 includes a tapered leading portion 122 formed at a free end thereof, and a locking slot 124 defined therein in the vicinity of the leading portion 122.

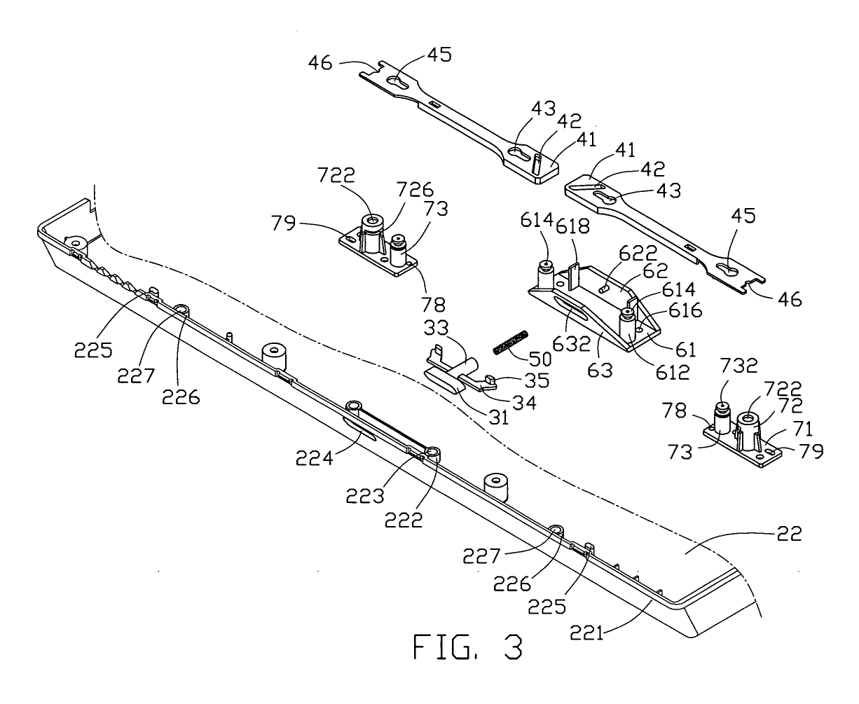

Referring also to FIG. 3, the base unit 20 includes a bottom panel 22, and a cover panel 24 covered on the bottom panel 22. The bottom panel 22 has a flange 221 extending up from one side thereof. A receiving slot 224 is defined in a middle portion of the flange 221. The bottom panel 22 forms two columns 222 adjacent to the receiving slot 224, two locating rods 225, and two mounting rods 226 adjacent to the locating rods 225 respectively. A rib (not labeled) is formed on the bottom panel 22 connected to the columns 222. A mounting hole 223 is defined in each column 222. The locating rods 225 and the mounting rods 226 extend from the bottom panel 22 away from the receiving slot 224. A mounting hole 227 is defined in each mounting rod 226. The cover panel 24 defines two through holes 242.

The button 30 includes an operating portion 31, a columnar portion 32 extending from one side of the operating portion 31, and two wings 34 extending from opposite sides of the columnar portion 32 respectively. Each wing 34 includes a driving portion 35 protruding up from a distal end thereof. Each driving portion 35 has a generally rhombic-shaped section. A receiving hole (not shown) is defined in the columnar portion 32 along a longitudinal axis thereof.

Each latch member 40 is elongate, and includes a locking end and a driven end 41 at opposite ends thereof respectively. A first restricting slot 43 and a second restricting slot 45 are defined in the latch member 40 in the vicinity of the driven end 41, and the locking end respectively. The first and second restricting slots 43, 45 each include a large end and a small end, respectively. An inclined sliding slot 42 is defined in the driven end 41. A U-shaped cutout is defined in the locking end, an arc-shaped latch portion 46 is formed at a bottom wall of the cutout.

The mounting member 60 includes a bottom wall 61, a trapezium-shaped first sidewall 62 and a trapezium-shaped second sidewall 63 extending up from a back and a front sides of the bottom wall 61 respectively. Two limiting poles 612, 614 protrude up from opposite ends of the bottom wall 61. A T-shaped limiting block 614 is formed on a top portion of each limiting pole 612. Two through holes 616 are defined in the bottom wall 61 in the vicinity of the two limiting poles 612 respectively and adjacent to the first sidewall 62. Two limiting plates 618 extend up from the bottom wall 61 in the vicinity of the first sidewall 62. A rod 622 protrudes from the first sidewall 62 toward the second sidewall 63. A through slot 632 is defined in a middle portion of the second sidewall 63.

Each supporting member 70 includes a base plate 71, a columnar supporting portion 72 and a pillar 73 extending up from the base plate 71. The supporting portion 72 defines a locking hole 722 therein along its longitudinal axis. A slot 726 is defined in a circumference of the supporting portion 72 perpendicular to the axis of the supporting portion 72 and communicating with the locking hole 722. A T-shaped limiting block 732 is formed on a top portion of the pillar 73 along an axis. A mounting hole 78 and a locating hole 79 are defined in the base plate 71.

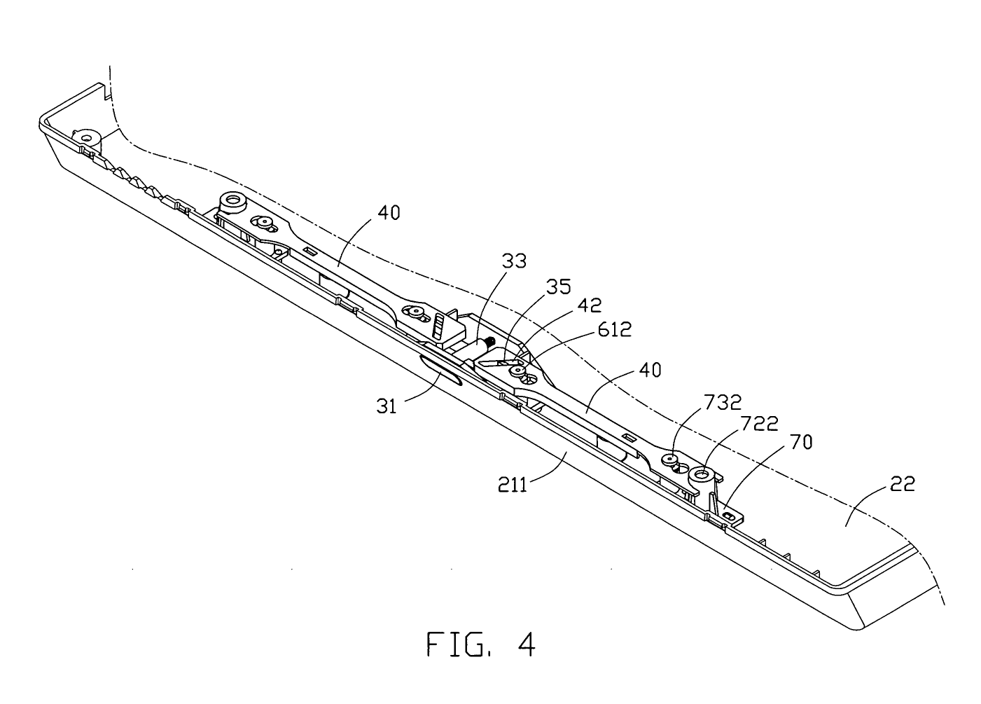

Referring also to FIG. 4, in assembly, two screws extend through the through holes 616 of the mounting member 60 to engage in the mounting holes 223 of the columns 222 of the bottom panel 22, for fixing the mounting member 60 to the bottom panel 22. One end of the resilient member 50 is received in the receiving hole of the columnar portion 33 of the button 30. The button 30 is placed between the first and second sidewalls 62, 63 of the mounting member 60. The operating portion 31 of the button 30 extends through the through slot 632 of the second sidewall 63 of the mounting member 60 to be retained in the receiving slot 224 of the flange 221 of the bottom panel 22 of the base unit 20. The other end of the resilient member 50 is fitted about the rod 622 of the first sidewall 62 of the mounting member 60.

Each supporting member 70 is fixed to the bottom panel 22 via the corresponding locating rod 225 of the bottom panel engaging in the locating hole 79 of the supporting member 70 and a screw extending through the mounting hole 78 of the supporting member 70 to engage in the mounting hole 227 of the corresponding mounting rod 226 of the bottom panel 22. The latch members 40 are located at the bottom panel 22 and at opposite sides of the receiving slot 224 respectively, each being fixed to a corresponding limiting pole 612 and the pillar 73 of a corresponding supporting member 70. The T-shaped limiting block 614 of the corresponding limiting pole 612 and the limiting block 732 of the pillar 73 are inserted through the large ends of the first and second restricting slots 43, 45 of the latch member 40. Each latch member 40 is moved away from the button 30, with the limiting block 614 of the corresponding mounting member 60 and the limiting block 732 of the corresponding supporting member 70 being accommodated in the small ends of the first and second restricting slots 43, 45 respectively. The driving portions 35 of the button 30 are engaged in the sliding slots 42 of the corresponding latch members 40. The locking ends of the latch members 40 are engaged in the slots 726 of the corresponding supporting members 70.

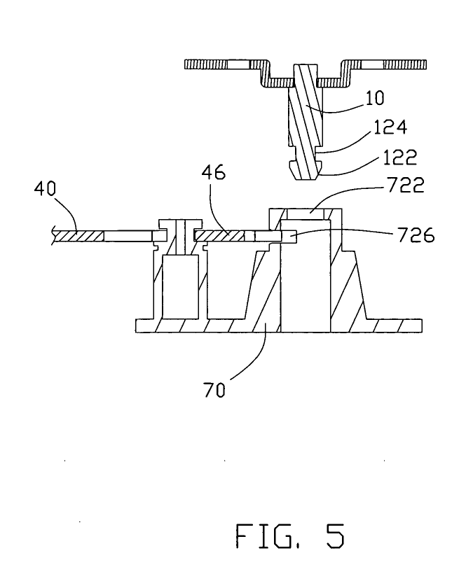

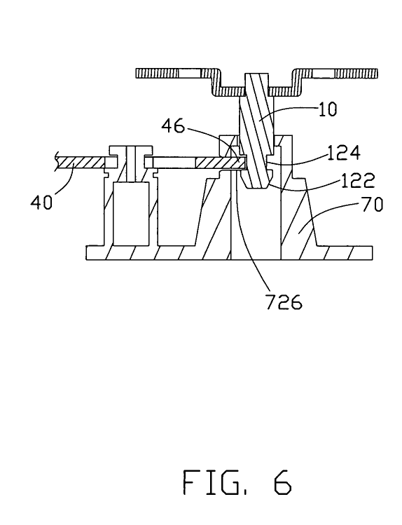

Referring also to FIGS. 5 and 6, the cover panel 24 is fixed to the bottom panel 22, thereby the base unit 20 is fully assembled. The cover unit 10 is rotatably attached to the base unit 20. The cover unit 10 is rotated to cover the base unit 20 when the electronic device is not in use. The leading portions 122 of the hooks 12 of the cover unit 10 extend through the corresponding through holes 242 of the cover panel 24 of the base unit 20 to abut against the latch portions 46 of the corresponding latch members 40. The cover unit 10 is further rotated, the leading portions 122 of the hooks 12 drive the latch members 40 to slide toward the button 30. The button 30 is driven to slide backward against the resilient member 50 and the driving portions 35 thereof slide along the sliding slots 42 of the latch members 40 respectively. After the leading portions 122 of the hooks 12 entirely extend through the latch members 40 respectively, the resilient member 50 rebounds to drive the button 30 to move forward. The driving portions 35 slide along the sliding slots 42 of the corresponding latch members 40 to drive the latch members 40 to move away from the button 30 until the latch portions 46 of the latch members 40 are engaged in the locking slots 124 of the hooks 12 respectively. Thus, the cover unit 10 is locked to the base unit 20.

To unlock the cover unit 10 from the base unit 20, the operating portion 31 of the button 30 is pressed to drive the button 30 move backward and compress the resilient member 50. The driving portions 35 of the button 30 slide in the sliding slots 42 of the latch members 40 respectively to drive the latch members 40 to move toward the button 30. When the latch portions 46 of the latch members 40 are disengaged from the locking slots 124 of the hooks 12, the cover unit 10 is released from the base unit 20.

Each limiting plate 618 of the mounting member 60 is used for blocking one side of a corresponding latch member 40 to restrict the latch member 40.

As a second embodiment of the present invention, the driving portions 35 of the button 30 can have a columnar shape or other shapes easily slidable in the sliding slots 42. Furthermore, The first and second sidewalls 62, 63, the two limiting poles 612, and the two limiting plates 618 can directly protrude from the bottom panel 22.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A latch mechanism for locking a cover unit to a base unit which comprises a bottom panel and a cover panel fixed to the bottom panel, a through hole defined in the cover panel, the latch mechanism comprising:
a latch member configured for being slidably installed to the bottom panel and between the bottom panel and the cover panel, the latch member comprising a latch portion and a sliding slot;
a hook protruding from the cover unit for extending through the through hole of the cover panel to engage with the latch portion of the latch member;
a button movably fixed to the bottom panel, the button comprising a driving portion sliding in the sliding slot of the latch member for driving the latch member to slide toward the button to disengage from the hook; and
a resilient member connected to the button configured for restoring the button.

2. The latch mechanism as claimed in claim 1, wherein a mounting member is fixed to the bottom panel for receiving the button, the mounting member comprises a bottom wall, a first sidewall extending from one side of the bottom wall, the resilient member is placed between the first sidewall and the button.

3. The latch mechanism as claimed in claim 2, wherein a limiting pole protrudes up from the bottom wall for supporting one end of the latch member.

4. The latch mechanism as claimed in claim 3, wherein a T-shaped limiting block is formed on a top portion of the limiting pole, a first restricting slot is defined in the latch member, the first restricting slot includes a large end adjacent to the button and a small end away from the button, the limiting block is inserted through the large end of the first restricting slot of the latch member, and moved to the small end of the first restricting slot.

5. The latch mechanism as claimed in claim 3, wherein a supporting member is fixed to the bottom panel away from the mounting member, a pillar extends up from the supporting member for supporting the other side of the latch member.

6. The latch mechanism as claimed in claim 5, wherein a T-shaped limiting block is formed on a top portion of the pillar, a second restricting slot is defined in the latch member, the second restricting slot includes a large end adjacent to the button and a small end away from the button, the limiting block of the pillar is inserted through the large end of the second restricting slot of the latch member, and moved to the small end of the second restricting slot.

7. The latch mechanism as claimed in claim 2, wherein a limiting plate extends up from the bottom wall of the mounting member in the vicinity of the first sidewall for limiting the latch member.

8. The latch mechanism as claimed in claim 1, wherein the resilient member is a coil spring.

9. The latch mechanism as claimed in claim 1, wherein the button comprises an operating portion, a columnar portion extending from one side of the operating portion, and a wing extending from one side of the columnar portion, the driving portion protrudes up from a distal end of the wing.

10. The latch mechanism as claimed in claim 9, wherein the driving portion is rhombic shaped.

11. The latch mechanism as claimed in claim 9, wherein a supporting member is fixed to the bottom panel, the supporting member includes a base plate, a columnar supporting portion extending up from the base plate, the supporting portion defines a locking hole along a longitudinal axis thereof, a slot is defined in a circumference of the supporting portion perpendicular to the axis of the supporting portion and communicating with the locking hole, the latch portion of the latch member is engaged in the slot of the supporting member, the hook extends through the through hole of the cover panel and the locking hole of the supporting member to engage with the latch portion of the latch member.

12. The latch mechanism as claimed in claim 9, wherein the hook comprises a tapered leading portion formed at a free end thereof, and a locking slot defined therein in the vicinity of the leading portion, the latch portion of the latch member is engaged in the locking slot.
